(19) United States
(12) Patent Application Publication
(10) Pub. No.: US 2005/0286278 A1
(43) Pub. Date: Dec. 29, 2005

(54) Method and apparatus for switched-mode power conversion at radio frequencies

(76) Inventors: David J. Perreault, Brookline, MA (US); Juan M. Rivas, Boston, MA (US); Riad Samir Wahby, Cambridge, MA (US); John S. Shafran, Santa Clara, CA (US)

Correspondence Address: Paul D. Durkee;Daly, Crowley, Mofford & Durkee, LLP, Suite 101, 275 Turnpike Street, Canton, MA, 02021-2354, US

(21) Appl. No.: 11/109,498

(22) Filed: Apr. 19, 2005

Related U.S. Application Data
(60) Provisional application No. 60/564,446, filed on Apr. 22, 2004.

(51) Int. Cl. H02J 1/10

(52) U.S. Cl. 363/65

(57) ABSTRACT

A switched mode dc-dc converter enables increases in switching frequency over conventional architectures. In one embodiment, a dc-dc converter has a Vernier-regulated architecture having unregulated cells and a regulating cell coupled to a controller. In another embodiment, a dc-dc-converter has a cell-modulation-regulated architecture.

### CROSS REFERENCE TO RELATED APPLICATIONS

The present application claims priority to U.S. Provisional Patent Application No. 60/564,446, filed on Apr. 22, 2004, which is incorporated herein by reference.

### STATEMENT REGARDING FEDERALLY SPONSORED RESEARCH

Not Applicable.

### BACKGROUND

A rapid evolution of technology is generating a demand for power electronics having capabilities greatly exceeding what is presently achievable. One particular challenge is the miniaturization of power electronic circuits due to energy storage and loss limitations of passive components used in the conversion process. There are further challenges in enabling power circuits to be fabricated in a more integrated fashion. Higher levels of integration can promote improved power density and enable the use of batch fabrication techniques that provide the cost benefits of integrated circuits and MEMS (Micro Electro-Mechanical Systems) systems. Thus, design and manufacturing methods that enable power electronics to be miniaturized and/or fabricated using batch processing techniques have potential value. Achieving miniaturization and integration of power electronic circuits will necessitate radical increases in switching frequency to reduce the required size of passive components.

Switching power converters traditionally comprise semiconductor switching devices and controls along with passive energy storage components, including inductors and capacitors. The passive components provide intermediate energy storage in the conversion process and provide filtering to attenuate the switching ripple to acceptable levels. Inductive elements, in particular, are used to achieve near-lossless transfer of energy through the circuit and to limit the instantaneous currents generated by the switching action of the power stage. These passive energy storage elements often account for a large portion of converter size, weight, and cost, making miniaturization difficult.

One means for achieving reduction in the size of power circuits is through increases in switching frequency. As is well known, the size of the energy storage elements (e.g., inductors and capacitors) required to achieve a given conversion function varies inversely with switching frequency. Much of the improvement in size and cost of switching power converters over time has been due to increases in switching frequency, rising from tens of kilohertz in the early 1970's into the megahertz range today. Increases in switching frequency have been achieved both through new devices and materials better suited to high-frequency operation (e.g., power MOSFETs and new ferrite magnetic materials) and through circuit and component designs that reduce losses associated with high-frequency switching.

Despite the availability of devices capable of operating up to several gigahertz under certain conditions, power converter switching frequencies remain in the low megahertz range and below. This is due to some of the challenges peculiar to power electronics. Switching power converters must typically operate efficiently over a wide load range (often in excess of 100:1) from a variable input voltage, and must regulate the output in the face of rapid and unpredictable load and input variations. However, existing circuit topologies capable of operating efficiently at high frequencies are not well-matched to these requirements. These topologies use a continuous resonating action to achieve the zero-voltage switching that is essential to operation at high radio frequencies and beyond. This approach is effective for full load conditions, where the losses associated with resonant operation are small compared to the output power. However, these resonating losses are present under all loading conditions, and are typically unacceptable in systems that must operate efficiently over a wide load range.

Another factor that has inhibited the use of higher switching frequencies in power electronics is the impact of frequency-dependent losses on magnetic component size. At high frequencies, loss limits—rather than energy storage limits—are the dominant consideration in sizing magnetics. The core loss densities of most power ferrite materials rise rapidly with frequency in the megahertz range, necessitating flux derating as frequency is increased. As a result, magnetic component size does not always decrease as frequency is increased, and can even worsen. Air-core magnetics designs do not suffer this limitation, but must be operated at still higher frequencies to compensate for reduced inductance resulting from the lack of permeable core material.

Achieving dramatic reductions in power converter size thus requires either new passive component designs that do not suffer this loss limitation or power conversion architectures capable of operating at sufficiently high frequencies that air-core magnetics can be employed effectively. The need to regulate the output represents a further difficulty with available power circuits capable of high frequency operation. While some degree of regulation can be achieved with such circuits (e.g., by frequency control), the difficulty in realizing regulation over a wide load range is only exacerbated as switching frequency increases. Moreover, converter dynamics and control circuit implementation complexities escalate at higher operating frequencies. These factors have placed major constraints on power converter operating frequencies and, in turn, on size and performance.

As is known the art, there are a variety of known converter architectures suffering from one or more of the disadvantages described above. Cellular power converter architectures utilize multiple power converters operating together (e.g., in parallel) to supply a load. Prior art dc-output cellular systems utilize regulated converter cells. In an activated regulated cell, feedback (e.g., deriving from cell or output voltage or current) is used to adjust the switching pattern of the cell in order to control its output. Typical regulated cell designs adjust the duty ratio (either directly or indirectly, e.g., via current-mode control), switching frequency, or switching phase shift of the cell in response to the feedback.

For example, K. Siri, C. Q. Lee, and T.-F. Wu, “Current Distribution Control for Parallel Connected Converters: Part 1,” IEEE Transactions on Aerospace and Electronic Systems, Vol. 28, No. 3, July 1992, pp. 829-840, which is incorporated herein by reference, proposes an approach in which the switching patterns of the activated cells are adjusted by feedback such that their output currents track together, and in combination regulate the output. The number of regulated cells activated is varied with load level to preserve high system efficiency across load.

Likewise, Kajouke, et. al., “High Efficiency Power System with Plural Parallel DC/DC Converters,” U.S. Pat. No. 6,166,934, Dec. 26, 2000, which is incorporated herein by reference, discloses parallel converter systems in which the activated cells are controlled to regulate their outputs to specified reference values and/or provide current sharing with other activated cells, and in which the number of regulated cells activated is varied across load to optimize efficiency.

A variety of feedback control approaches are known that provide current sharing and/or output control in parallel converter systems by appropriately adjusting the switching patterns of activated cells. See, for example, S. Luo, Z. Ye, R.-L. Lin and F. C. Lee, “A Classification and Evaluation of Paralleling Methods for Power Supply Modules,” 1999 IEEE Power Electronics Specialists Conference, pp. 901-908, June 1999, which is incorporated herein by reference.

Regulation of a system output by on-off control has been explored previously in single-converter systems, such as in Y. Lee and Y. Cheng, “A 580 khz switching regulator using on-off control,” Journal of the Institution of Electronic and Radio Engineers, vol. 57, no. 5, pp. 221-226, September/October 1987, which is incorporated herein by reference. The use of on-off control in parallel rf amplifier architectures to provide good efficiency over a wide range of rf output power has also been explored, as described in A. Shirvani, D. K. Su and B. A. Wooley, “A CMOS RF Power Amplifier with Parallel Amplification for Efficient Power Control,” IEEE Journal of Solid-State Circuits, Vol. 37, No. 6, pp. 684-693, June 2002, which is incorporated herein by reference.

### BRIEF DESCRIPTION OF THE DRAWINGS

The exemplary embodiments contained herein will be more fully understood from the following detailed description taken in conjunction with the accompanying drawings, in which:

FIG. 1 is a block diagram of a converter having a Vernier-regulated architecture;

FIG. 2 is a graphical depiction of unregulated cell activation in a converter system having a Vernier-regulated architecture;

FIG. 3 is a schematic depiction of a Vernier cell and control circuit for a Vernier-regulated converter system;

FIG. 4 is a block diagram of converter having a cell-modulation-regulated architecture

FIG. 4A is a schematic depiction of a Class E inverter circuit;

FIG. 5 is a graphical depiction showing waveforms for signals in the inverter circuit of FIG. 4;

FIG. 6 is a schematic depiction of a feedback circuit for a switching device in an inverter circuit;

FIG. 7 is a graphical depiction of magnitude and phase for a transfer function from the switch drain voltage to the switch gate voltage;

FIG. 8 is a schematic depiction of a self-oscillating resonant gate drive circuit;

FIG. 9 is a schematic diagram of an unregulated converter cell;

FIG. 10 is a graphical depiction of cell performance as a function of supply voltage;

FIG. 11 is a graphical depiction of attenuated drain-source voltage;

FIG. 12 is a graphical depiction of attenuated drain-source voltage during turn-on and turn-off transients;

FIG. 13 is a graphical depiction of converter efficiency versus power;

FIG. 14 is another graphical depiction of converter efficiency versus power;

FIGS. 15A and 15B are graphical depictions of converter dynamic performance;

FIGS. 16A and 16B are graphical depictions of time-domain waveforms;

FIGS. 17A and 17B are graphical depictions of transient behavior;

FIGS. 18A and 18B are graphical depictions of output power and efficiency versus input voltage.

### DETAILED DESCRIPTION

The present invention provides inventive apparatus, methods and architectures for switched-mode dc/dc power conversion enabling dramatic increases in switching frequency while preserving features in practice, including regulation of the output across a wide load range and high light-load efficiency. This is achieved in part by how the energy conversion and regulation functions are partitioned. The structure and control approach of the new architectures are described, along with representative implementation methods. The design and experimental evaluation of prototype systems with cells operating at 100 MHz are also shown and described herein. The inventive approaches allow substantial improvements in the size of switching power converters to be achieved and, in some cases, to permit their integrated fabrication.

The inventive architectures for dc/dc power conversion enable dramatic increases in switching frequencies into the very-high frequency (VHF) and microwave/ultra-high frequency (UHF) range, and enable miniaturization of dc/dc converters. As used herein, architecture refers to the manner in which a power electronic system is structured and controlled. A given architecture can be realized with a range of particular converter topologies.

In contrast to various known converter architectures, such as those disclosed in the present Background of the Invention, the present invention incorporates unregulated converter cells, as described in detail below. The switching pattern of an unregulated cell, as used herein, is not adjusted via feedback to provide control of the cell or system output when the cell is activated. The use of unregulated cells removes the necessity to adjust the switching pattern (e.g., duty ratio or frequency) when a cell is activated, thereby facilitating the use of radio-frequency conversion topologies, resonant gate drives and/or multi-stage amplifiers, self-oscillating controls, and narrow-band passive networks in the design to achieve very high operating frequencies.

Moreover, in the present invention, changing the number of activated cells is used as a means of achieving regulation rather than as a method for optimizing efficiency within the control range of a set of regulating converter cells. Regulation of the output by modulating on and off cells of a multi-cell converter system has substantial advantages over doing so with a single converter, as the stresses imposed on the input and output filter components can be made substantially lower, as can the required modulation rate for a given output ripple.

Before describing the invention in detail, some background information helpful in describing the invention is provided. The inventive architectures incorporate certain circuit structures and principles that are employed in tuned radio-frequency power amplifiers, but apply them in manners that overcome limitations in conventional dc/dc converter architectures. Some of the characteristics of these circuits are now reviewed.

Switched-mode RF amplifiers (inverters) utilize resonant circuit operation to achieve zero-voltage switching of the semiconductor devices. To minimize driving losses and achieve high power gains, multistage amplifier designs are often used. In a multi-stage design, amplifiers are chained together such that each amplifier efficiently drives the gate(s) of a higher power amplifier; the last amplifier in such a chain drives the output. Using these techniques, tuned inverters can be designed to operate with good efficiency into the gigahertz range, and in some cases can be completely integrated. Similar (including dual) circuits can be used for efficient high-frequency rectification. Both inverter and rectifier circuits of this type exhibit certain limitations.

They only operate with good efficiency over a relatively narrow load range, both because of the continuous resonating losses described above and because the load greatly affects the operating waveforms. In addition, the controllability of these designs (e.g., to compensate for load or input variations) is limited, and becomes more challenging at higher frequencies and in multi-stage amplifiers. Thus, the practical use of these circuits in dc/dc power conversion has been limited to relatively low frequencies (<30 MHz), as previously described.

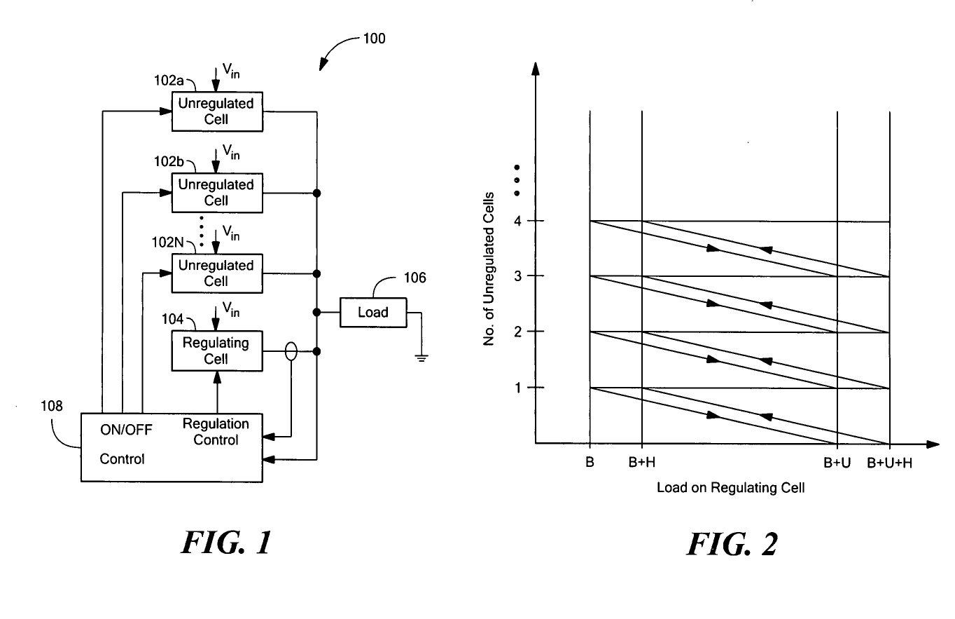

FIG. 1 shows an exemplary Vernier-regulated cellular architecture (VRCA) 100 including a number of unregulated converter cells 102 a-N and a regulating converter cell 104, each of which supplies the output to a load 106. As described more fully below, the unregulated cells 102 each comprise an RF inverter, a transformation stage, and a rectifier, along with filtering and ancillary circuitry. The unregulated cells 102 are structured such that they may be activated or deactivated (turned on or off) by a controller 108.

The regulating converter cell 104, or Vernier cell, may be a switched-mode converter, a linear regulator, or some combination thereof, and need only be rated for a small fraction of the total system power. It should be noted that the regulating cell is termed a Vernier cell by analogy to the Vernier scale on a caliper (named after its designer, Pierre Vernier). As is well known, the Vernier scale provides incremental measurements between the discrete marks on the main scale of a caliper; likewise, the Vernier cell provides incremental power between the discrete power levels that can be sourced via the unregulated cells.

Operation of the Vernier-regulated cellular architecture 100 is as follows: The regulating cell 104 is controlled to regulate the output at the desired level. As the load varies, unregulated cells 102 are activated or deactivated to keep the regulating converter within a specified load range while ensuring that the active unregulated cells 102 run at or near their ideal operating points.

An exemplary activation scheme that can be implemented in the controller 108 is graphically illustrated in FIG. 2. The number of active unregulated cells 102 (FIG. 1) is shown versus the load on the regulating cell. In the steady state, the unregulated cells 102 deliver a portion of the total power (in discrete increments), while the regulating cell 104 provides whatever remaining power is needed to regulate the load voltage. That is, unregulated cells 102 are activated or deactivated based on the load on the regulating cell 104, where U is the incremental loading change when an unregulated cell is activated or deactivated, B is the minimum load on the regulating cell, below which an unregulated cell is deactivated, and H is a hysteresis value to prevent chattering at boundaries.

This arrangement has a number of advantages. The unregulated cells 102 run under a narrow range of loading conditions. In addition, the control required for the unregulated cells 102 is a simple on/off command. These characteristics facilitate the use of high frequency multi-stage amplifier designs for the unregulated cells 102. Furthermore, because inactive cells do not incur loss, and unregulated cells 102 are only activated as needed to support the load, efficient light-load operation can be achieved. Also, the inventive architecture inherits a number of advantages of conventional cellular converter architectures, including the dispersal of heat generation in the circuitry and the potential for fault tolerance.

As will be readily appreciated by one of ordinary skill in the art, in power converter systems that processes power through multiple channels, each channel should stably carry the appropriate amount of power in order to avoid circulating losses and the possible destructive overload of individual channels and components therein. In the inventive Vernier-regulated architecture, it should be ensured that the unregulated cells 102 share power in the desired manner. Furthermore, the unregulated cells 102 should not interfere with the output control function of the regulating cell 104.

In general, these control goals can be achieved by appropriately shaping the output impedances of the individual cells. For a given operating point, the cells are modeled as Thevenin equivalent voltages and impedances that drive the output filter and load. For the regulating cell 104, the Thevenin source is equal to the reference voltage, while the Thevenin (output) impedance depends on both the power stage and control loop design. For the unregulated cells 102, the Thevenin model parameters depend on the input voltage, the cell power stage design, and the cell switching frequency. To achieve the desired output control, the regulating cell 104 is designed to have low output impedance at low frequencies (down to dc), while the unregulated cells 102 are designed to have relatively high output impedances (and thus act as current sources). High dc output impedance is achievable with appropriate rectifier design, and can also be used to ensure that the unregulated cells share power (and current) correctly via-their “droop” characteristics. Thus, through appropriate design, the control requirements of the inventive Vernier-regulated architecture can be met.

The architecture described above uses a Vernier cell 104 operating at variable load to provide the difference between the quantized power levels delivered by the unregulated cells 102 and that needed to regulate the output.

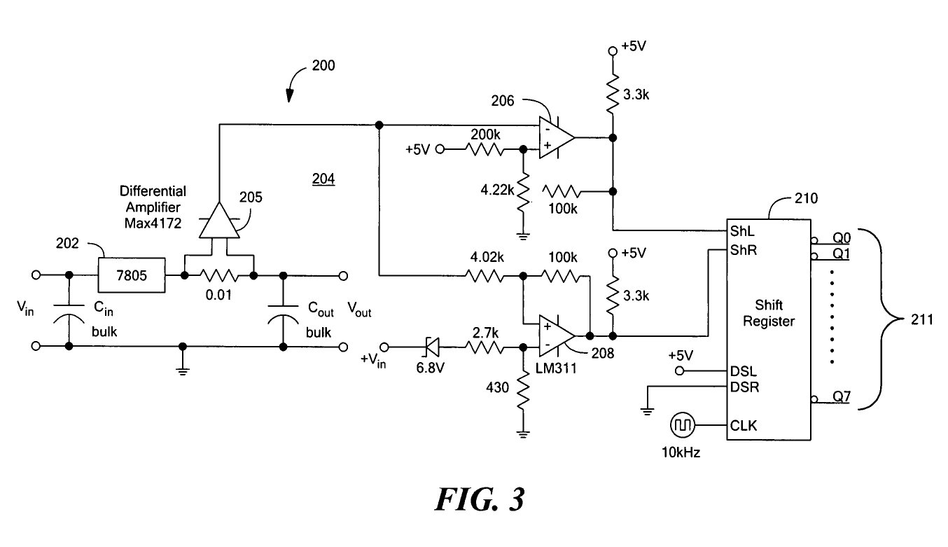

FIG. 3 shows an exemplary embodiment of an exemplary circuit 200 including a regulating or Vernier cell 202, which can correspond to the regulating cell 104 in FIG. 1, and a control circuit 204, which can correspond to the controller 108 of FIG. 1. In the illustrated circuit implementation the regulating cell 202 includes a linear regulator, which can be provided as part number LM7805 Positive Voltage Regulator by Fairchild Semiconductor. In one embodiment, the control circuit 204 includes a current sensor 205, two comparators 206, 208, and two four-bit bidirectional shift registers 210. When the Vernier cell 202 output current exceeds a predefined upper threshold as detected by the comparators 206, 208, a shift command is sent to the shift register 210, which activates via the shift register outputs 211, one additional unregulated cell. That is, the shift register outputs 211 are used to control the unregulated cells. Likewise, when the lower threshold is crossed, the resulting command causes one unregulated cell to be turned off. Note that in the illustrated embodiment, the shift register outputs 211 are inverted to produce the appropriate active-low control signals to the unregulated cells. To prevent oscillation, the difference between the upper and lower switching thresholds should be larger than the maximum unregulated cell output current. On the other hand, too large a hysteresis band underutilizes the unregulated cells, costing converter efficiency.

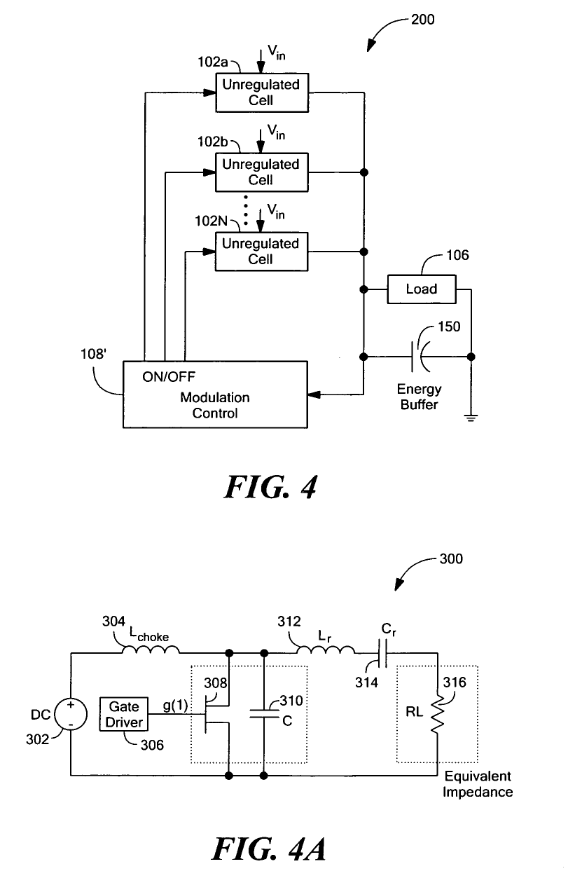

A cell-modulation-regulated architecture 200 uses unregulated cells 102′ to supply the output, as illustrated in FIG. 4. Unregulated cells 102′ are turned on and off by a modulation controller 108′ to energize a load 106 with an energy buffer 150, such as a capacitor, coupled across the load. The unregulated cells 102′ have high output impedance (such that they may be treated as current or power sources) and to admit on/off control. To provide the proper average power to regulate the output, the number of unregulated cells 102′ that are activated is modulated over time, and the energy buffer 150 (e.g., a capacitor, ultracapacitor, battery, etc.) at the converter output is used to filter the resulting power pulsations.

A variety of modulation strategies are compatible with this approach. For example, hysteretic control of the output voltage can be used. If the output voltage falls below a specified minimum threshold, the number of activated cells 102′ is increased (e.g., in a clocked or staggered fashion) until the output voltage returns above the minimum threshold (or until all cells are activated). If the output voltage rises above a specified maximum threshold, the number of activated cells 102′ is decreased until the output voltage returns below the maximum threshold (or until all cells are deactivated). In the case where a single cell is used, this corresponds to bang-bang control of the output. With multiple cells this approach might be considered a form of multi-level pulse-width modulation of power (or current). The system control can optionally be formulated as a sigma-delta modulator or other discrete pulse modulation technique.

It is understood that other similar control strategies will be readily apparent to one of ordinary skill in art to likewise provide a desired average output voltage. The exemplary cell-modulation-regulated architecture may exhibit advantages over the architecture of FIG. 1. More particularly, the unregulated cells 102′ need to operate under on/off control over a narrow power range. This facilitates the use of very high frequency power converter cells having small size and high efficiency, and enables high light-load efficiency to be achieved. However, considerations of sizing input and output filters for this architecture may be different than the architecture of FIG. 1.

In the Vernier architecture of FIG. 1, the size of the output filter (e.g. output capacitor) needed depends primarily on the bandwidth of the regulating (Vernier) cell, and secondarily on the startup speed of the unregulated cells if at all. By contrast, in the cell-modulation-regulated architecture of FIG. 4, the energy storage requirement and size of the output filter capacitor 150 depends on the rate at which the unregulated cells 102′ can be modulated on and off-typically orders of magnitude slower than the switching frequency of the cells themselves. Consequently, the ultra-high frequency operation of the cells enables dramatic reductions in size of power stage components (e.g., inductors; capacitors, and transformers), but it may not benefit the input and output filter components to the same extent. Nevertheless, in many applications, substantial energy storage is provided at one or both converter ports (e.g. for holdup), so this is often acceptable.

Thus, the illustrative cell-modulation regulated architecture enables high efficiency across load and significant reductions in power stage component size, but does not provide the same degree of improvement for input and output filters.

The architectures described above enable dramatic increases in switching frequency as compared to conventional designs, with consequent benefits. It should be appreciated that there are many variants that offer similar advantages. For example, if one is willing to accept regulation of the output to discrete levels, one can utilize a set of unregulated cells without the need for a Vernier cell or time-domain modulation to interpolate between levels. The use of unregulated cells having different power ratings (e.g., a geometric 2^{N} progression) facilitates this approach, though it would perforce increase the design effort. Note that the use of non-uniform cell sizing can benefit the above architectures as well. The underlying characteristic of such approaches is that they partition the energy conversion and regulation functions in manners that are compatible with the effective use of ultra-high frequency circuit designs and techniques.

The inventive architectures admit a wide range of unregulated cell designs in which the cells should operate efficiently for at least a narrow specified operating range, have high output impedances, and be amenable to on/off control. These features can be fulfilled by a variety of RF (Radio Frequency) circuit topologies, and permit cell designs having switching frequencies significantly higher than those reached in conventional dc/dc converters.

An exemplary design and experimental evaluation of an illustrative inventive converter cell operating at 100 MHz that achieves >75% efficiency over its operating range is presented below. An unregulated cell includes a high frequency inverter, an impedance matching network, and a resonant rectifier. The inverter is driven by a self-oscillating gate driver at a free running frequency of 100 MHz.

FIG. 4A shows a front end of an unregulated cell 300, such as unregulated cell 102a in FIG. 1) including a Class E resonant inverter. The cell 300 includes a dc voltage source 302 coupled to an input choke inductor 304. A gate driver 306 controls a switch 308 to which an energy storage device, such as a capacitor 310, is coupled in parallel. A resonant inductor 312 is coupled in series with a resonating capacitor 314. The cell energizes a resistive load 316, representing the transformation stage and rectifier.

In conventional RF design, the loaded Q (QL) of the converter is usually chosen to be large, resulting in waveforms with high spectral purity. For power conversion, however, the requirements on QL are different, since the goal is to maximize power transfer with minimum loss. A low value of QL results in less energy resonated in the tank, which further implies reduced conduction loss in the parasitic elements of the inverter.

Under optimal ZVS (Zero Voltage Switching) conditions, inverter output power is proportional to the capacitance of the capacitor 310 in parallel with the switch 308. For the intended range of output power in the practical cell implementation, the required capacitance was provided entirely by the parasitic drain-source capacitance associated with the switch 308. In one particular embodiment, the device selected for the main switching element 308 is a Laterally Diffused MOSFET (LDMOSFET). This semiconductor device offers the required characteristics needed to operate at high frequencies: it presents an acceptable drain to source capacitance and a low gate capacitance that allows for minimum gating loss.

In power converters, gating losses grow with switching frequency. In traditional topologies, these losses often become the limiting factor for high frequency operation. To mitigate these losses and recover some of the energy required to operate the semiconductor switch, a resonant gate driver may be used. A resonant gate drive often implies sinusoidal gate signals, a feature commonly found in cascaded power amplifiers. A low-cost, efficient means of selectively driving the inverter is desirable for the inventive architectures. To achieve this goal while maintaining cell simplicity, a self-oscillating gate driver making use of the drain-source voltage vds(t) of the LDMOSFET was implemented. By properly shifting the fundamental component of the drain voltage, this resonant network generates a sinusoidal gating signal capable of sustaining oscillation at the desired frequency.

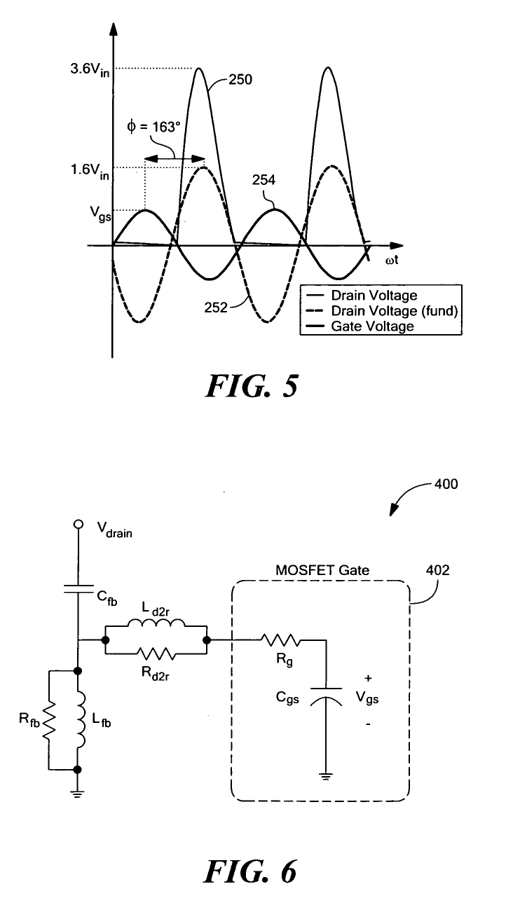

FIG. 5 shows an idealized vds(t) 250 and its fundamental (dotted line) 252. The gate signal 254 is also shown. The phase angle between the fundamental component 252 of the drain voltage and the idealized gate signal 254 is 163 degrees. These waveforms are referred in phase to the required gate voltage, vgs(t).

FIG. 6 shows a linear circuit structure 400, including the internal parasitics 402 of the LDMOS (Laterally Diffused Metal Oxide Semiconductor) gate, providing the appropriate phase shift to attain sustained oscillations. A feedback capacitor Cfb, which has a first terminal connected to the drain voltage, is coupled at a second terminal in series with a parallel connection of a feedback (damping) resistor Rfb and feedback inductor Lfb. A parallel coupling of a drain inductor Ld2r and drain resistor Rd2r is coupled at one end to the LDMOSFET gate 402 and at the other end to the second terminal of the feedback capacitor Cfb. The circuit 400 feeds back the drain to source voltage vds(t) of the LDMOS gate and provides the required phase shift. The fundamental of vds(t) is also attenuated to a value that ensures proper gate drive and is below the gate breakdown voltage (vgs,max=20 V).

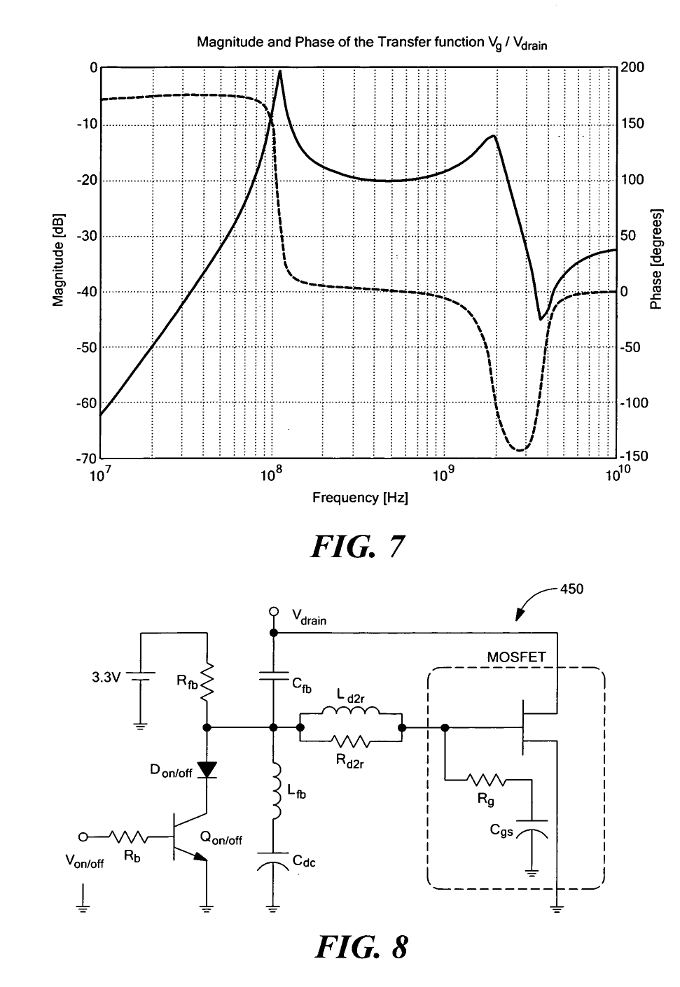

FIG. 7 shows the frequency response of the drain to gate transfer function V_{gs}/V_{ds}(ω); at 100 MHz the phase is the required 163 degrees. By properly adjusting the damping resistor Rfb it is possible to set the magnitude and the precise frequency of oscillation. The function of Ld2r and Rd2r is to damp the second resonance apparent in the transfer function of FIG. 7; higher frequency oscillations (≈2 GHz) might otherwise result.

The input impedance of the self-oscillating structure is dominated by the value of the feedback capacitor Cfb. This capacitor is selected such that the impedance looking into the structure is higher than the impedance looking into the resonant tank of the Class E inverter, ensuring that the frequency characteristics of the tank circuit are not substantially altered.

The inventive architecture requires a control signal which starts and stops cell operation. This can be achieved with a modification to the phase shift/feedback network, as illustrated in the circuit 450 FIG. 8. When transistor Qon/off is on, the gate is pulled low and the inverter is shut off. When transistor Qon/off turns off, capacitor Cdc charges through the feedback resistor Rfb. With a properly chosen logic supply voltage (e.g., 3.3 V in FIG. 8), the gate is driven above threshold, turning on the MOSFET and starting oscillation through the phase shift/feedback network. A digital signal can thus be used to activate or inhibit converter operation.

During operation, Cdc remains biased close to the MOSFET threshold voltage, helping to keep the duty ratio near 50%. Cdc is selected for minimal impact on the transfer function Vgs/Vds(ω). When Qon/off is off, the junction capacitance of Don/off appears in series with the output capacitance of Qon/off; this minimizes loading on the phase shift/feedback network.

The RC circuit formed by Rfb and Cdc introduces a delay between the command signal and inverter startup; it is this delay which limits the speed at which the cell can be turned on.

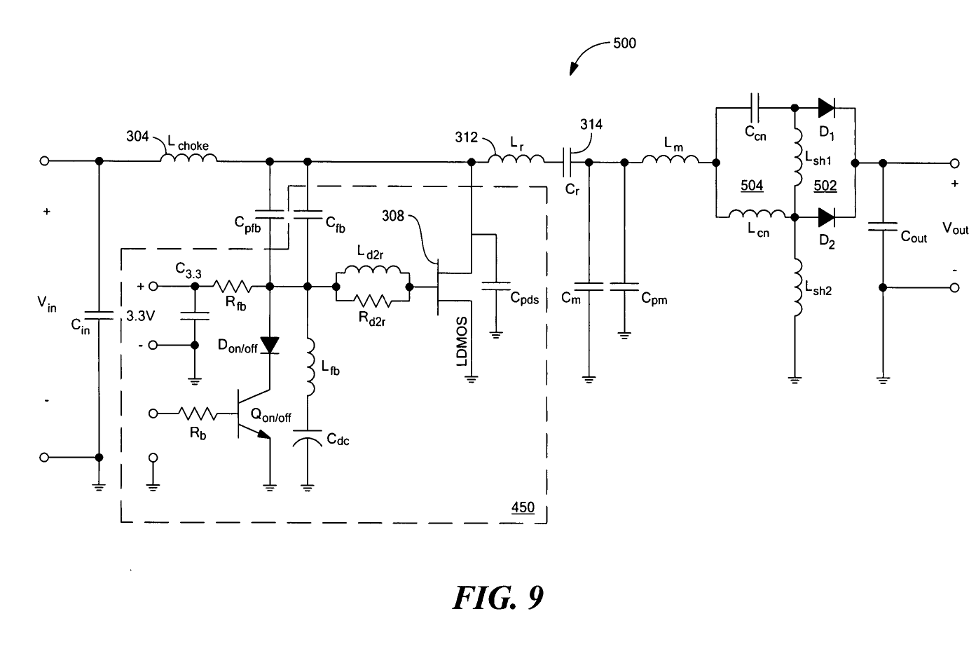

FIG. 9 shows an exemplary unregulated 100 MHz switching dc/dc power converter 500, which includes the components in the circuit 450 of FIG. 8, and cell 102 of FIG. 1, where like reference numbers indicate like elements. Table 1 below lists illustrative component values.

TABLE I
Component Values In The Unregulated Cell

| Circuit Element | Nominal Value | Part Number |
|---|---|---|
| L_{choke} | 538ₙH | Coilcraft 132-20SMJ |
| C_{fb} | 2ₚF | CDE MC08CA020C |
| C_{pfb} | 1.15ₚF | Measured circuit board parasistic |
| L_{fb} | 27ₙH | Coilcraft 1812SMS-27NG |
| R_{fb} | 2.2 Ω | Standard SMD |
| C_{dc} | 2.2ₙF | C0G Ceramic, 50 V |
| R_{b} | 100 kΩ | Standard SMD |
| L_{d2r} | 2.5ₙH | Coilcraft A01TJ |
| R_{d2r} | 15 Ω | Standard SMD |
| C_{pds} | 5.9ₚF | Measured circuit board parasitic |
| Lᵣ | 68 ₙH | Coilcraft 1812SMS-SMS-68N |
| Cᵣ | 57ₚF (47ₚF + 10ₚF) | CDE MC12FA470J |
| | | CDE MC08CA100D |
| Cₘ | 47ₚF | CDE MC12FA470J |
| Cₚₘ | 2.4ₚF | Measured circuit board parasitic |
| Lₘ | 12.5ₙF | Coilcraft A04TJ |
| C_{cn} | 100ₚF | CDE MC12FA101J |
| L_{cn} | 22ₙH | Coilcraft 1812MS-22NG |
| Lₛₕ₁ | 12.5ₙH | Coilcraft A04TJ |
| Lₛₕ₂ | 12.5ₙH | Coilcraft A04TJ |
| Cᵢₙ | 4 × 47ₙF | X7R Ceramic, 50 V |
| Cₒᵤₜ | 9 × 47ₙF | X7R Ceramic, 50 V |
| C_{3.3} | 2 × 47ₙF | X7R Ceramic, 50 V |
| LDMOSFET | | PD57018S |
| D₁D₂ | | MBRS1540T3 |
| D_{on/off} | | BAS70 |
| Q_{on/off} | | BC847 |

As shown in FIG. 9, an exemplary rectifier network 502 is implemented as a balanced pair of single-diode rectifiers D1, D2. The rectifier network 502 is structured such that it appears resistive in a describing function sense. This rectifier is connected to the inverter tank by a simple L-section matching network 504. Circuit board parasitics Cpfb, Cpds, and Cpm, are also described.

Experimental Results

Cell efficiency and output power for the exemplary unregulated converter 500 of FIG. 9 were measured over the supply voltage range of 11 to 16 V with a constant-voltage load comprising fifteen 5.1 V, 1 W Zener diodes in parallel with two 15 μF Tantalum capacitors. Output power ranged from approximately 2.5 to 6 W, with an average efficiency greater than 77.5%.

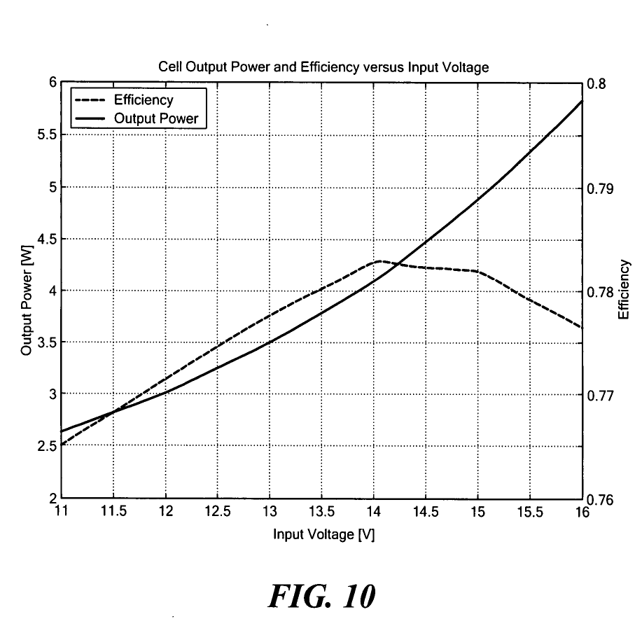

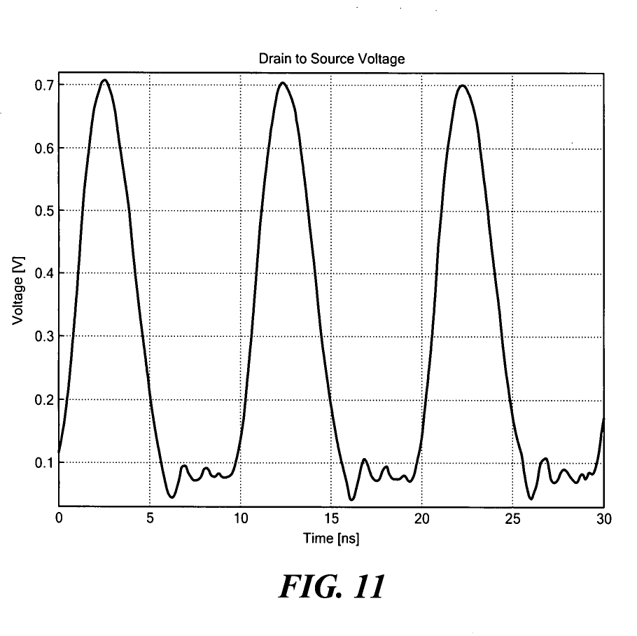

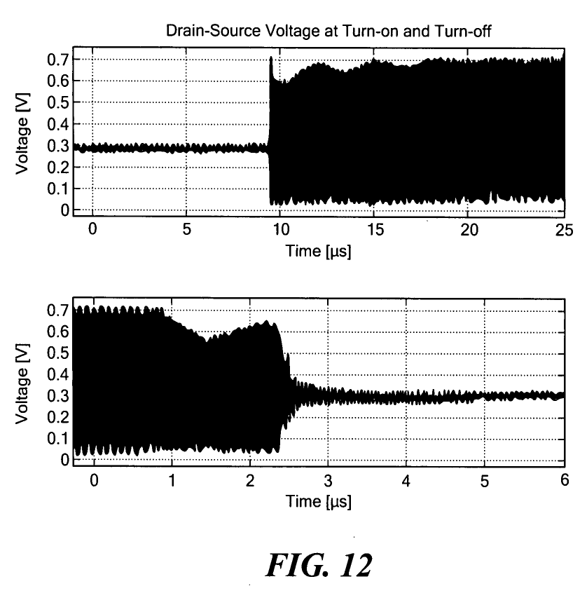

FIG. 10 illustrates measurements from a typical cell showing output power in Watts versus input voltage. FIG. 11 shows measured drain-source voltage under nominal conditions. FIG. 12 shows turn-on and turn-off transients (the command occurs at t=0 in both cases). The drain-source voltage was measured through a resistive attenuator in order to minimize loading on the drain node; as a result, the measured magnitude is approximately 38 times smaller than the voltage present at the drain. The incremental output impedance of the unregulated cell design at Vout=5 V ranged from 30 (Vin=11 V) to 3 (Vin=16 V). The unregulated cell switching frequency, 100 MHz, is significantly higher than those found in conventional dc/dc converter designs, while maintaining an acceptable efficiency level. The switching and gating losses in this design were very low. Further increases in operating frequencies are contemplated using substantially the same switching device and circuit topology. In addition, topological modifications are contemplated to improve power and performance levels.

To demonstrate operation of a Vernier-regulated converter, such as that shown in FIG. 1, a prototype system was designed comprising eight unregulated cells, such as those shown in FIG. 9, and a Vernier cell 202 and control circuit 204, such as that shown in FIG. 3. In this implementation an LM7805 Positive Voltage Regulator by Fairchild Semiconductor was used as the Vernier cell. The linear regulator maintains constant (though low) efficiency down to almost zero load. Moreover, the use of an otherwise extremely inefficient regulator in this system demonstrates the efficiency potential of the Vernier-regulated architecture despite regulating cell loss.

As is clear from FIG. 10, unregulated cell output current is a rather strong function of input voltage. Thus, were a static upper hysteresis threshold chosen (necessarily accommodating the output current at Vin=16 V), substantial underutilization of the unregulated cells would occur at lower supply voltages. To mitigate the consequent losses, the upper hysteresis threshold is instead made a function of Vin via a Zener diode and a resistive attenuator, as shown in FIG. 3.

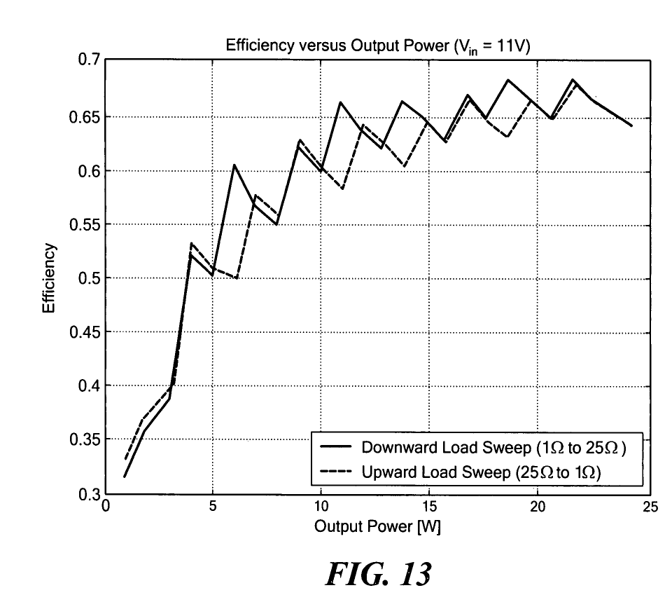

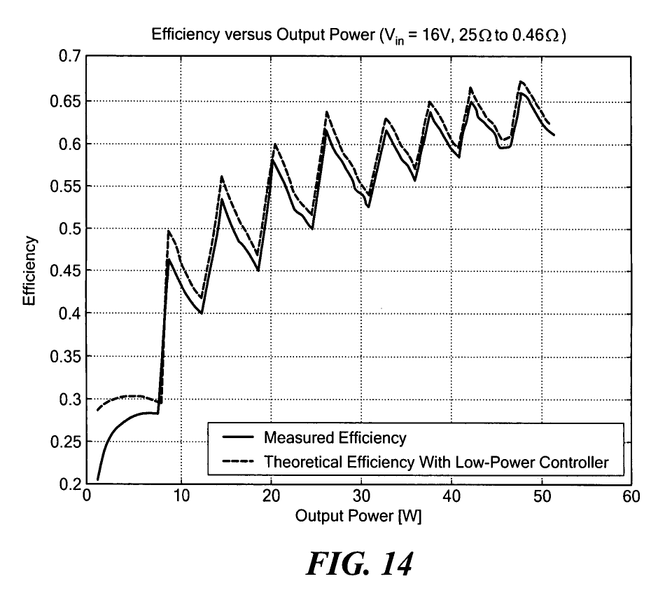

The VRCA converter, over the full supply and load ranges, achieved over 68% peak efficiency. FIGS. 13 and 14 show measured efficiency versus load at Vin=11 V and Vin=16 V, respectively. When an unregulated cell is switched on, power processing shifts from the low efficiency regulating cell to the high-efficiency unregulated cell. This causes a sudden jump in converter efficiency, resulting in the sawtooth waveform pattern apparent in both figures. The hysteretic nature of the control strategy employed in this converter gives rise to the possibility of two distinct operating configurations for the same load condition.

For the results shown in FIG. 13, the load was swept from nearly zero to maximum and then back. During the upward sweep, cell activation lagged the increasing load, resulting in the utilization of only the minimum number of cells necessary to power the load. On the downward sweep, cell deactivation lagged the changing load; as a result, during some portions of the downward sweep more power was processed by the high efficiency unregulated cells than during the upward sweep.

Conversion efficiency suffers somewhat at light load because of the power drawn by the controller. In this prototype converter, the control circuitry draws 80 mA of quiescent current from the supply, resulting in substantial loss, especially under light load conditions. FIG. 14 shows the theoretical efficiency impact of an implementation utilizing a low-power controller. Such a controller could be readily implemented through a variety of means. Static line regulation was measured at 25 W across the supply range of the converter; over this range the output voltage varied by 75 mV, or less than 1.5%. Static load regulation was better than 0.8% at Vin=11 V and 2.4% at Vin=16 V. Measured output voltage ripple was less than 200 mV at Vin=11 V, Rload=1 and less than 300 mV at Vin=16 V, Rload=0.46.

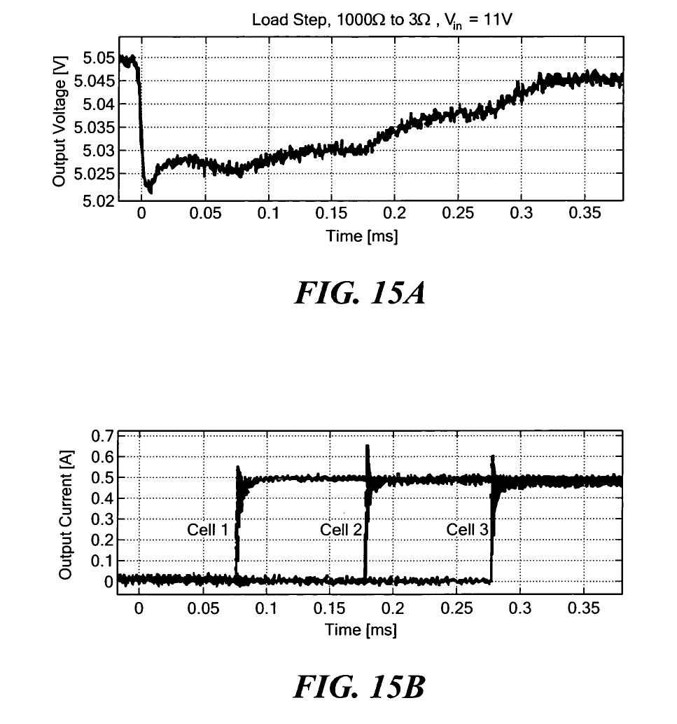

Dynamic load regulation is illustrated in FIGS. 15A and 151B. At Vin=11 V, the load was stepped from 1000 Ohms to 3 Ohms, resulting in the activation of the first three of the eight unregulated cells. The delay between cell activations is determined by the controller clock frequency, 10 kHz. In order to better match the power throughput of the unregulated cells, three of the eight cells were minimally trimmed to compensate for component variation. At maximum load with Vin=16 V, individual cell output currents were matched to within +6.5% of average. This is sufficient for practical purposes, and it is expected that with tighter component tolerances or more extensive trimming enhanced load sharing can be achieved.

Cell-Modulated Example

A prototype cell-modulation regulated converter such as that shown in FIG. 4, was constructed. In the prototype, a single 100 MHz dc/dc cell is modulated, through its on/off control input, with a hysteretic controller, which keeps the output voltage within predefined boundaries. Thus, the cell operates at an output voltage at which its efficiency is maximized. For one particular experimental implementation the hysteresis is implemented using a voltage comparator (Part No. LM311 of Fairchild Semiconductor), and limits the voltage swing to be between 4.9 and 5.1 V. The unregulated cell is provided with an (electrolytic) output capacitance of 320 μF.

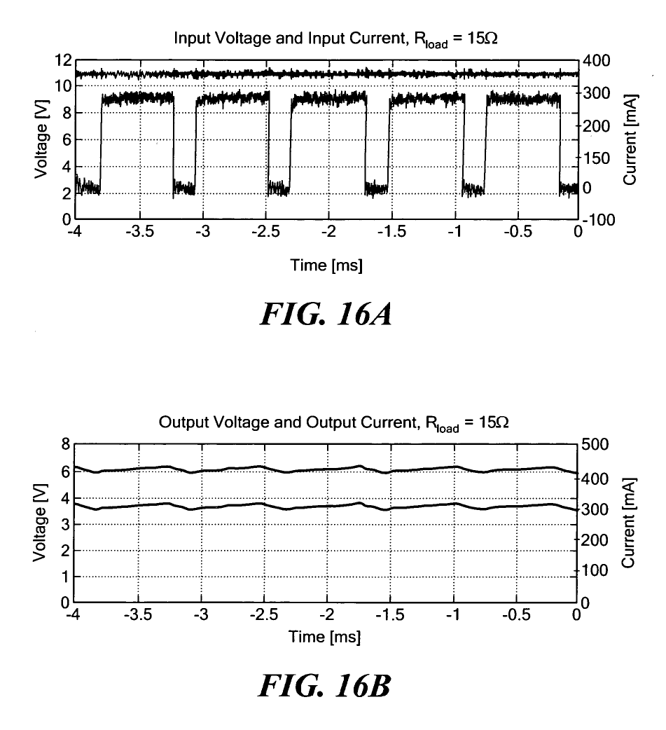

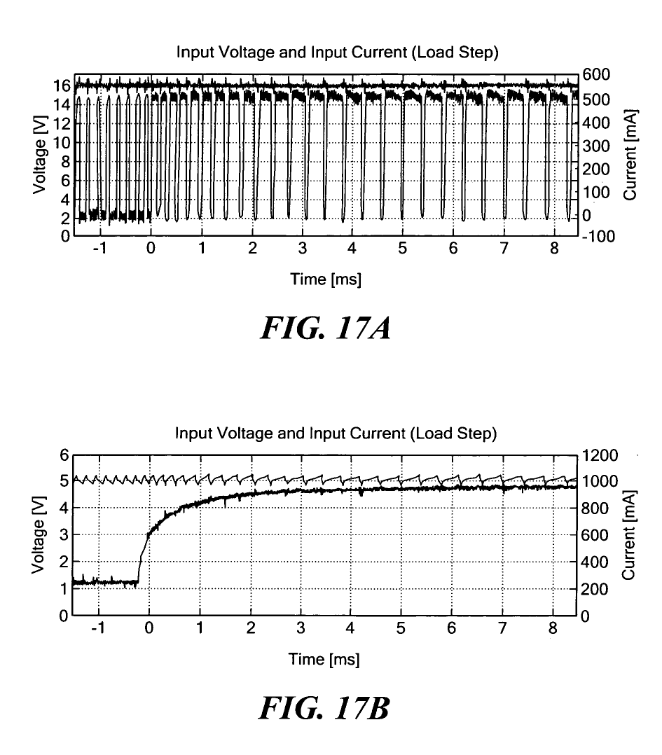

FIGS. 16A and 16B show experimental measurements of the time modulated architecture system operating at an input voltage of 11 V with a 15 Ohm resistive load. FIG. 17A also shows the input current of the cell, which pulsates with a frequency depending on the input voltage, the output capacitance, and output load.

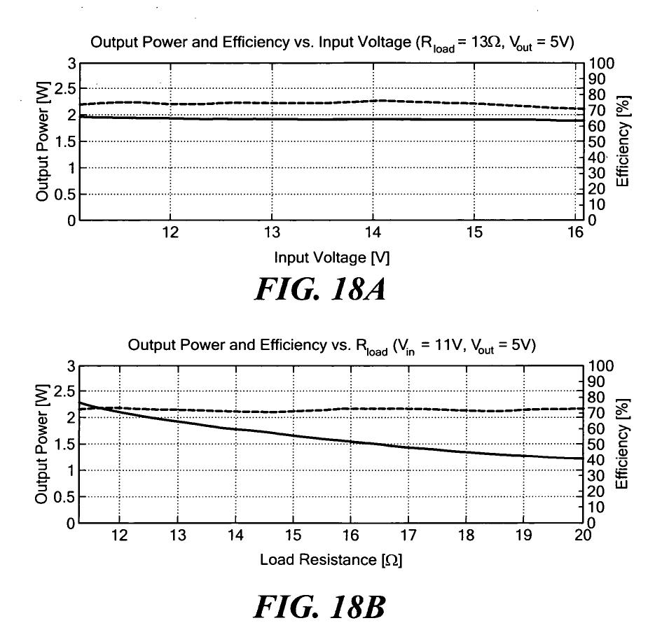

FIGS. 17A and 17B show the transient response of the time-domain architecture when a step change in the output load is applied. In particular, FIG. 18A shows a step change in load (20 Ohms to 5 Ohms, Vin=16 V). Under such a step change, the output voltage remains within the predefined limits.

The performance of the prototype is shown in FIGS. 18A and 18B; the output power and efficiency are plotted as a function of the input voltage and as function of the load connected. FIGS. 19A, B show that the overall efficiency of this architecture is high over the entire input voltage range.

As noted above, the inventive converter requires a relatively small amount of time to reach nominal operation at startup; if the time during which the converter is starting occupies an appreciable portion of the switching cycle, a small amount of loss results. Nevertheless, under rated conditions the efficiency remains quite high. As can be seen from the prototype system and results, the high cell switching frequency allows reduction in the power stage component sizes. However, the frequency of the input and output waveforms depends on the time modulation of the cell, and have lower frequency content. It is anticipated that the use of higher operating frequencies permitted by this architecture (e.g. to >1 GHz), the use of more cells, and design and control of cells for more rapid startup and shutdown will together enable substantial improvements in the input and output ripple performance of this architecture promise to break the frequency barrier that has until now constrained the design of switched-mode power converters, while preserving features critical in practice, including regulation of the output across a wide load range and high light-load efficiency. This is achieved in part by how the energy conversion and regulation functions are partitioned in the inventive architectures.

Other embodiments are within the scope of the following claims.

1. A power converter system, comprising:
a regulating converter cell, wherein the operation of the regulating converter cell can be adjusted under closed-loop control to regulate output of the regulating converter cell;
at least one unregulated converter cell that may be selectively activated, wherein a switching pattern of an activated one of the at least one unregulated converter cell is not adjusted via feedback to control output of the activated one of the at least one unregulated converter cell; and
a control circuit to regulate output of the converter system by activating and deactivating the at least one unregulated converter cell and adjusting operation of the regulating converter cell.

2. The system according to claim 1, wherein the at least one unregulated converter cell includes an inverter operating at an output frequency of above 30 MHz.

3. The system according to claim 1, wherein the regulating converter cell includes at least one of a switched mode converter and a linear regulator.

4. The system according to claim 1, wherein the regulating converter cell is controlled to regulate the output at the desired level, and an appropriate number of unregulated converter cells are activated and deactivated over time to maintain the regulating converter cell within a desired load range.

5. A dc-output power converter system comprising:
a plurality of unregulated power converter cells that may be selectively activated, wherein a switching pattern of an activated one of the plurality of unregulated power converter cells is not adjusted via feedback to control its output; and
a control circuit to regulate converter system output by activating and deactivating at least one of the plurality of unregulated power converter cells to control the converter system output.

6. The system according to claim 5, wherein the plurality of unregulated power converter cells each comprise:
a resonant dc-output power converter; and
a resonant drive circuit coupled to the resonant dc-output power converter including means for enabling and disabling a drive circuit to activate and deactivate the power converter.

7. The system according to claim 5, wherein the control circuitry regulates the output by keeping a portion of a number of cells needed to supply a required power continuously activated, and modulating an additional portion of the unregulated cells on and off over time to provide an average power needed for regulation beyond that provided by the continuously activated cells.

8. A dc-output power converter system for converting and controlling power from an input to an output, comprising:
a plurality of unregulated dc-output switching power converter cells, wherein the unregulated cells may be selectively activated, and operate at substantially fixed switching frequencies and duty ratios when activated; and
a control circuit that activates and deactivates the unregulated cells over time to regulate system output.

9. The power converter system according to claim 8, wherein the unregulated cells each comprise:
an inverter;
a rectifier; and
a reactive network that transfers energy from the inverter to the rectifier.

10. The power converter system of claim 9, wherein the inverters further include self-oscillating resonant driver circuits including a mechanism for enabling and disabling the self oscillation to activate and deactivate the cells.

11. The power converter system according to claim 8, wherein the unregulated cells operate at switching frequencies above 30 MHz.

12. The power converter system according to claim 8, further including a regulating converter cell to operate under closed-loop control to provide an incremental amount of power beyond that provided by the activated unregulated cells necessary to regulate output at the desired level.

13. A method, comprising:
providing a regulating converter cell that can be adjusted under closed-loop control to regulate output of the regulating converter cell; and
coupling at least one unregulated converter cell that may be selectively activated to a control circuit, wherein a switching pattern of an activated one of the at least one unregulated converter cell is not adjusted via feedback to control output of the activated one of the at least one unregulated converter cell, wherein the control circuit regulates output of the converter system by activating and deactivating the at least one unregulated converter cell and adjusting operation of the regulating converter cell.

14. The method according to claim 13, wherein the at least one unregulated converter cell includes a radio frequency inverter.

15. The method according to claim 13, wherein the regulating converter cell includes at least one of a switched mode converter and a linear regulator.

16. The method according to claim 13, wherein the regulating converter cell is controlled to regulate the output at the desired level, and an appropriate number of unregulated converter cells are activated and deactivated over time to maintain the regulating converter cell within a desired load range.

17. A method, comprising:
coupling a control circuit to a plurality of unregulated dc-output power converter cells to selectively activate the cells, wherein a switching pattern of an activated one of the plurality of unregulated power converter cells is not adjusted via feedback to control its output; and
regulating converter system output by activating and deactivating the plurality of unregulated power converter cells to control the converter system output.

18. The method according to claim 17, wherein the plurality of unregulated power converter cells each comprise:
a resonant dc-output power converter; and
a resonant drive circuit coupled to the resonant dc-output power converter for enabling and disabling a drive circuit to activate and deactivate the plurality of unregulated power converter cells.

19. The method according to claim 18, wherein the control circuitry regulates the output by keeping a portion of a number of cells needed to supply a required power continuously activated, and modulating an additional portion of the unregulated cells on and off over time to provide an average power needed for regulation beyond that provided by the continuously activated cells.

20. The method according to claim 17, wherein at least one of the plurality of unregulated power converter cells operates with a switching frequency of at least 100 MHz.
